(19) United States
(12) Patent Application Publication
(10) Pub. No.: US 2021/0136577 A1
(43) Pub. Date: May 6, 2021

(54) METHOD AND A DEVICE FOR WIRELESS CONNECTION

(71) Applicant: SHANGHAI LIANSHANG NETWORK TECHNOLOGY CO., LTD., Shanghai (CN)

(72) Inventors: Yuting LIU, Shanghai (CN); Liang LI, Shanghai (CN); Zhenyu SONG, Shanghai (CN)

(21) Appl. No.: 17/145,421

(22) Filed: Jan. 11, 2021

Related U.S. Application Data
(63) Continuation of application No. PCT/CN2019/095414, filed on Jul. 10, 2019.

(30) Foreign Application Priority Data
Jul. 10, 2018 (CN) 201810753186.6

(51) Int. Cl. H04W 12/06; H04W 48/16; H04W 76/10; H04W 12/08

(52) U.S. Cl. CPC H04W 12/06; H04W 12/08; H04W 76/10; H04W 48/16

(57) ABSTRACT

The present application is to provide a method and a device for wireless connection. In the present application, when a user needs to establish a wireless connection with a wireless hotspot which cooperates/is allied with a networking application installed on a user equipment, the user only needs to perform a connection operation on at least one cooperative wireless access point currently acquired through scanning and displayed by a wireless network system interface of the user equipment, so that the user equipment invokes the networking application and its corresponding platform server, and a routing device to which the target wireless access point belongs and its routing server in the background to authenticate wireless connection to the target wireless access point after the user equipment detects the connection operation, and thus the wireless connection between the user equipment and the target wireless access point is established to acquire a wireless network.

### CROSS-REFERENCE TO RELATED APPLICATIONS

This application is a continuation of and claims priority to International Patent Application PCT/CN2019/095414, filed Jul. 10, 2019, which claims priority to Chinese Patent Application No. 201810753186.6, filed Jul. 10, 2018, the contents of which are hereby incorporated by reference in their entirety.

### TECHNICAL FIELD

The present application relates to computers, and more specifically relates to a method and a device for wireless connection.

### BACKGROUND

With the approach of the information era, the demand for information sharing and data transmission has been increasing, and convenience of wireless transmission is favored by people. Ways of wireless transmission, such as Bluetooth etc., can be utilized to realize pairing between electronic devices, such as mobile terminals etc., and wireless transmission of information files. With the development of electronic technology, many electronic devices, such as mobile terminals etc., have installed built-in wireless transmission functions.

In the prior art, in an aspect, electronic devices, such as mobile terminals etc., are authenticated in a manner of open network SMS to implement wireless connection. The sorest point is the inconvenience of use. Typing a mobile phone number is required every time to acquire an authentication code for authentication, which brings cumbersome operations and poor experiences to users. In another aspect, electronic devices, such as mobile terminals etc., are authenticated in a manner of following a WeChat public account, which requires accepting advertisement pushes from the public account, and imposes risks of leaking critical user information.

### SUMMARY

An objective of the present application is to provide a method and a device for wireless connection, so as to solve the problems of bringing cumbersome operations and poor experiences to users caused in the process of establishing a wireless connection in the prior art.

According to an aspect of the present application, it is provided a method, implemented at a user equipment, for wireless connection. The method comprises:

scanning to acquire and display at least one cooperative wireless access point on a wireless network system interface;

transmitting a connection authentication request for a target wireless access point of the at least one cooperative wireless access point to a platform server when it is detected that a user performs a connection operation on the target wireless access point, wherein the connection authentication request comprises identification information of the target wireless access point;

receiving connection authentication request feedback information returned by the platform server, wherein the connection authentication request feedback information comprises a connection permission or a connection prohibition; and

establishing a wireless connection with the target wireless access point when the connection authentication request feedback information is a connection permission.

Further, in the above method, implemented at the user equipment, for wireless connection, when the connection authentication request feedback information is a connection prohibition, the method comprises:

receiving prompt information which is returned by the platform server and is used to indicate that a wireless connection cannot be established with the target wireless access point; and

displaying the prompt information which is used to indicate that a wireless connection cannot be established with the target wireless access point via the wireless network system interface. Further, in the above method, implemented at the user equipment, for wireless connection, transmitting the connection authentication request for the target wireless access point of the at least one cooperative wireless access point to the platform server when it is detected that the user performs the connection operation on the target wireless access point comprises:

invoking a networking application installed on the user equipment in the background and transmitting, by the networking application, the connection authentication request for the target wireless access point to the corresponding platform server when it is detected that the user performs the connection operation on the target wireless access point of the at least one cooperative wireless access point.

Further, in the above method, implemented at the user equipment, for wireless connection, at the same time when invoking the networking application installed on the user equipment in the background, the method further comprises:

transmitting, by the networking application, a query request to the platform server, wherein the query request comprises the identification information of the target wireless access point, so that the platform server queries whether the target wireless access point corresponding to the identification information is a cooperative wireless access point, and if so, the platform server returns, to the networking application, query request feedback information which is used to indicate that the target wireless access point is a cooperative wireless access point; and

transmitting the connection authentication request for the target wireless access point to the platform server when the networking application receives, from the platform server, the query request feedback information which indicates that the target wireless access point is a cooperative wireless access point.

Further, in the above method, implemented at the user equipment, for wireless connection, after establishing the wireless connection with the target wireless access point when the connection authentication request feedback information is a connection permission, the method further comprises:

when it is detected that the wireless connection through the target wireless access point is not working, transmitting a connection retry request for the target wireless access point to the platform server based on a detected reconnection operation on the target wireless access point by the user, wherein the connection retry request comprises the identification information of the target wireless access point.

According to another aspect of the present application, it is also provided a method, implemented at a platform server, for wireless connection. The method comprises:

receiving a connection authentication request for a target wireless access point transmitted by a user equipment, wherein the connection authentication request comprises identification information of the target wireless access point;

transmitting a release request for the target wireless access point to a routing server to which a routing device belongs, wherein the target wireless access point corresponding to the identification information belongs to the routing device;

receiving release request feedback information returned by the routing server; and

when the release request feedback information is a release success, transmitting information on the release success to the user equipment, so that the user equipment establishes a wireless connection with the target wireless access point.

Further, in the above method, implemented at the platform server, for wireless connection, if the release request feedback information is a release failure, transmitting, to the user equipment, prompt information which is used to indicate that a wireless connection cannot be established with the target wireless access point, so that the user equipment displays the prompt information which is used to indicate that a wireless connection cannot be established with the target wireless access point via the wireless network system interface.

According to another aspect of the present application, it is also provided a method, implemented at a routing server, for wireless connection. The method comprises:

receiving a release request for releasing a target wireless access point transmitted by a platform server, wherein the release request comprises identification information of the target wireless access point;

transmitting a release instruction to a routing device to which the wireless access point corresponding to the identification information belongs, wherein the release instruction comprises a release rule carrying the identification information of the target wireless access point; and

receiving release instruction feedback information transmitted by the routing device, and transmitting the release instruction feedback information to the platform server, so that the platform server transmits the release instruction feedback information to a user equipment, wherein the release instruction feedback information comprises a release successor a release failure.

According to another aspect of the present application, it is also provided a method, implemented at a routing device, for wireless connection. The method comprises:

receiving a release instruction transmitted by a routing server, wherein the release instruction comprises a release rule carrying identification information of a target wireless access point; and

returning release instruction feedback information to the routing server after release authentication on the target wireless access point corresponding to the identification information is performed based on the release rule, so that the routing server transmits the release instruction feedback information to the platform server, wherein the release instruction feedback information comprises a release success or a release failure.

According to another aspect of the present application, it is also provided a system for wireless connection. The system comprises a user equipment, a platform server, a routing server and a routing device, wherein:

the user equipment is configured to: scan to acquire and display at least one cooperative wireless access point on a wireless network system interface; transmit a connection authentication request for a target wireless access point of the at least one cooperative wireless access point to the platform server when it is detected that a user performs a connection operation on the target wireless access point, wherein the connection authentication request comprises identification information of the target wireless access point;

the platform server is configured to: receive the connection authentication request for the target wireless access point transmitted by the user equipment, wherein the connection authentication request comprises the identification information of the target wireless access point; and transmit a release request for the target wireless access point to the routing server to which the routing device belongs, wherein the wireless access point corresponding to the identification information belongs to the routing device;

the routing server is configured to: receive the release request for releasing the target wireless access point transmitted by the platform server, wherein the release request comprises the identification information of the target wireless access point; and transmit a release instruction to the routing device to which the wireless access point corresponding to the identification information belongs, wherein the release instruction comprises a release rule carrying the identification information of the target wireless access point;

the routing device is configured to: receive the release instruction transmitted by the routing server, wherein the release instruction comprises the approval rule carrying the identification information of the target wireless access point; and return release instruction feedback information to the routing server after release authentication on the wireless access point corresponding to the identification information is performed based on the release rule, so that the routing server transmits the release instruction feedback information to the platform server, wherein the release instruction feedback information comprises a release success or a release failure;

the platform server is configured to: receive the release request feedback information returned by the routing server, when the release request feedback information is a release success, transmit information on the release success to the user equipment; and

the user equipment is configured to: receive connection authentication request feedback information returned by the platform server, wherein the connection authentication request feedback information comprises a connection permission or a connection prohibition; establish a wireless connection with the target wireless access point when the connection authentication request feedback information is a connection permission.

According to another aspect of the present application, it is also provided a nonvolatile storage medium having computer-readable instructions stored thereon. The computer-readable instructions, executable by a processor, cause the processor to implement the above mentioned method for wireless connection.

According to a further aspect of the present application, it is also provided a user equipment for wireless connection. The user equipment comprises:

one or more processors; and

a nonvolatile storage medium for storing one or more computer-readable instructions,

wherein the one or more computer-readable instructions, when executed by the one or more processors, cause the one or more processors to implement the above mentioned method, implemented at the user equipment, for wireless connection.

According to another aspect of the present application, it is also provided a platform server for wireless connection. The platform server comprises:

one or more processors; and

a nonvolatile storage medium for storing one or more computer-readable instructions,

wherein the one or more computer-readable instructions, when executed by the one or more processors, cause the one or more processors to implement the above mentioned method, implemented at the platform server, for wireless connection.

According to another aspect of the present application, it is also provided a routing server for wireless connection. The routing server comprises:

one or more processors; and

a nonvolatile storage medium for storing one or more computer-readable instructions,

wherein the one or more computer-readable instructions, when executed by the one or more processors, cause the one or more processors to implement the above mentioned method, implemented at the routing server, for wireless connection.

According to a further aspect of the present application, it is also provided a routing device for wireless connection. The routing device comprises:

one or more processors; and

a nonvolatile storage medium for storing one or more computer-readable instructions,

wherein the one or more computer-readable instructions, when executed by the one or more processors, cause the one or more processors to implement the above mentioned method, implemented at the routing device, for wireless connection.

Compared with the prior art, in the present application, when a user needs to acquire a wireless network, at least one cooperative wireless access point currently acquired through scanning is displayed via a wireless network system interface of a user equipment to the user at the user equipment. When it is detected that the user performs a connection operation on a target wireless access point of the at least one cooperative wireless access point, the user equipment transmits a connection authentication request for the target wireless access point to a platform server corresponding to a networking application installed on the user equipment, so that the platform server transmits a release request for releasing the target wireless access point to a routing server which cooperates with/is authorized by the networking application based on the connection authentication request. As such, the routing server performs authentication interaction with the routing device based on the release request to obtain release request feedback information on the target wireless access point, and transmits the release request feedback information to the platform server. The platform server returns connection authentication request feedback information to the user equipment based on the release request feedback information, and thus the routing server and the routing device's pre-release of the target wireless access point to be connected and which is acquired through scanning by the user equipment is achieved. The user equipment then can establish a wireless connection with the target wireless access point based on the received connection authentication request feedback information which is used to indicate a connection permission, and display prompt information on the wireless network system interface which indicates that the wireless connection has been established. Not only that the user can establish a wireless connection between the user equipment and the selected target wireless access point so as to acquire the wireless network as long as the user performs a connection operation on at least one cooperative wireless access point currently acquired through scanning and displayed by the wireless network system interface of the user equipment, but the user is also able to timely know the fact that the wireless connection has been established through the intuitively displayed prompt information by the wireless network system interface which is used to indicate that the user equipment has established the wireless connection with the target wireless access point, which simplifies operations performed by the user in the process of establishing a wireless connection, and enables the user to intuitively and timely know the result that the wireless connection has been established through the prompt information, thereby further improving user experience.

### DESCRIPTIONS OF THE DRAWINGS

Other features, objects, and advantages of the present application will become more apparent by reading the detailed description of non-limiting embodiments with reference to the following drawings:

FIG. 1 shows a schematic diagram of process interactions of a method for wireless connection according to an aspect of the present application;

FIG. 2 shows a schematic diagram of determination process interactions for a release authentication mode for a target wireless access point to be connected in a method for wireless connection according to an aspect of the present application; and

FIG. 3 shows a logical schematic diagram of wireless connection to a target wireless access point to be connected on a networking application installed on a user equipment in a method for wireless connection according to an aspect of the present application.

The identical or similar reference numerals in the drawings represent the identical or similar components.

### DETAILED EMBODIMENTS

The application is further described in detail below with reference to the accompanying drawings.

In a typical configuration of the present application, a terminal, a device of a service network and a trusted party all include one or more processors (CPUs), an input/output interface, a network interface and a memory.

The memory may include a memory in form of a non-permanent memory, a random access memory (RAM) and/or a non-volatile memory and the like in a computer-readable medium, such as a read-only memory (ROM) or a flash memory (flashRAM). A memory is an example of a computer-readable medium.

A computer-readable medium comprises permanent and non-permanent, movable and non-movable media and may implement information storage by means of any method or technology. Information may be computer-readable instructions, data structures, program modules or other data. The examples of a computer storage medium include but are not limited to a phase change memory (PRAM), a static random access memory (SRAM), a dynamic random access memory (DRAM), other types of random access memory (RAM), a read-only memory (ROM), an electrically erasable programmable read-only memory (EEPROM), a flash memory or other memory technologies, compact disk read-only memory (CD-ROM), a digital versatile disc (DVD) or other optical storages, a magnetic cassette tape, and magnetic tape and magnetic disk storage or other magnetic storage devices or any other non-transmission media, which can be used to store information that can be accessed by a computing device. According to the definition herein, the computer-readable medium does not include a non-transitory computer-readable medium, such as a modulated data signal and a carrier.

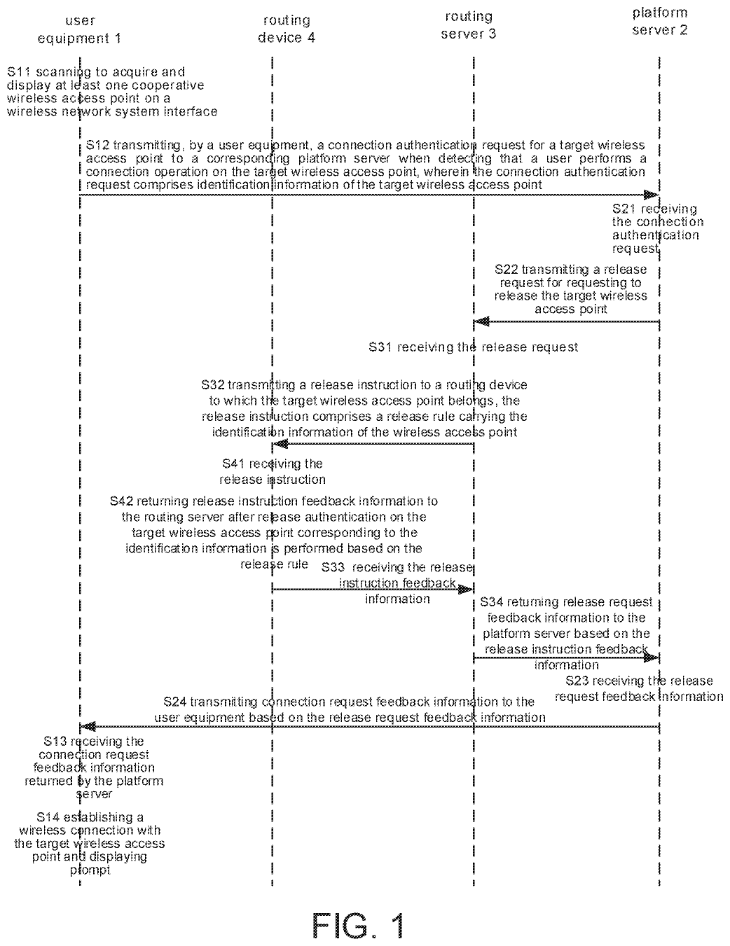

As shown in FIG. 1, a schematic diagram of process interactions of a method for wireless connection provided by an embodiment of the present application is shown. The process of wireless connection involves a user equipment, a routing device (AC/AP), a routing server, and a platform server. The method is applied in the process of wireless connection in which: a user invokes a networking application on the user equipment by performing an operation on a wireless hotspot via a wireless network system interface of the user equipment so as to enable the user equipment to connect to a target wireless access point corresponding to the routing device which cooperates with or is authorized by the networking application. The target wireless access point is a hotspot corresponding to the routing device which corresponds to a cooperator/authorizer of the networking application for wireless connection. The method comprises: step S11, step S12, step S13, step S14, step S21, step S22, step S23, step S24, step S31, step S32, step S33 and step S34. In specific, the method comprises:

when a user enters into an area with hotspots, user equipment 1 which the user holds scans to acquire all hotspots in its vicinity which are currently available for connection. In step S11, user equipment 1 scans and acquires at least one cooperative wireless access point via a wireless network system interface of user equipment 1, and displays the at least one cooperative wireless access point(s) on the wireless network interface, so that the user can intuitively learn one or more cooperative wireless access points which are currently available for wireless connection from the wireless network system interface, wherein the one or more cooperative wireless access points are one or more hotspots corresponding to a router device which cooperates with or is authorized by the networking application installed on user equipment 1, such as an application of WIFI master key, etc.

When the user needs to establish a wireless connection with a hotspot which cooperates/is allied with the networking application, the user selects a target wireless access point from at least one cooperative wireless access point displayed in the wireless network system interface through a connection operation for wireless connection. Here, the connection operation on the target wireless access point by the user may be a click operation, a sliding operation, as well as a drag operation on the target wireless access point, etc., so as to achieve the purpose of selecting the target wireless access point. That is, in step S12, when user equipment 1 detects that the user performs a connection operation on a target wireless access point of the at least one cooperative wireless access point, user equipment 1 transmits a connection authentication request for the target wireless access point to platform server 2 corresponding to the networking application installed on user equipment 1, wherein the connection authentication request comprises identification information of the target wireless access point. Thus, when the user performs a connection operation on the target wireless access point via the wireless network system interface of user equipment 1 which the user holds, the networking application installed on user equipment 1, such as an application of WIFI master key, etc., is invoked in the background, so that platform server 2 corresponding to the network application wireless access point.

Here, at the same time when user equipment 1 invokes the networking application installed on user equipment 1 in the background, the networking application also transmits a query request to platform server 2, wherein the query request comprises the identification information of the target wireless access point, so that platform server 2 queries, among all the cooperative wireless access points stored locally, whether the target wireless access point corresponding to the identification information is a cooperative wireless access point. If so, platform server 2 returns, to the networking application, query request feedback information which is used to indicate that the target wireless access point is a cooperative wireless access point, so that the networking application can timely learn the fact that the target wireless access point which is currently selected for connection is a cooperative wireless access point. Thus, when the networking application receives, from the platform server, the query request feedback information which indicates that the target wireless access point is a cooperative wireless access point, the networking application transmits the connection authentication request for the target wireless access point to the platform server. As such, the networking application is able to query whether the target wireless access point is a cooperative wireless access point before transmitting the connection authentication request to the platform server.

In step S12, after user equipment 1 transmits the connection authentication request for the target wireless access point to platform server 2 corresponding to the networking application installed on user equipment 1, platform server 2 needs to transmits a release request for releasing the target wireless access point to routing server 3 based on the connection authentication request firstly. Thus, pre-release authentication on the target wireless access point is performed by routing server 3 and routing device 4 to which the target wireless access point belongs. Not only release authentication on wireless connection to the target wireless access point is realized through the platform server corresponding to the networking application installed on the user equipment, the routing device to which the target wireless access point belongs and its routing server, but cumbersome operations resulting from authentication by inputting user identifier, such as a mobile phone number, etc., or by following a WeChat public account in the process of traditional wireless connection, and even security issues such as user information leakage, etc. are also avoided, thereby simplifying operations in the process of wireless connection while guaranteeing user privacy and improving user experience.

After user equipment 1 transmits the connection authentication request to platform server 2, in step S21, platform server 2 receives the connection authentication request for the target wireless access point transmitted by user equipment 1.

In step S22, platform server 2 determines routing device 4 to which the target wireless access point corresponding to the identification information belongs according to the identification information of the target wireless access point in the connection authentication request, and transmits a release request for the target wireless access point to routing server 3 to which routing device 4 belongs. That is, platform server 2 requests to release the target wireless access point from routing server 3 to which routing device 4 belongs, so that the user equipment can connect to the released target wireless access point, wherein the target wireless access point corresponding to the identification information belongs to routing device 4.

In step S31, routing server 3 receives the release request for releasing the target wireless access point transmitted by platform server 2, wherein the release request comprises the identification information of the target wireless access point. Here, platform server 2 directionally transmits the release request to the current routing server 3 in response to determining the routing device to which the target wireless access point belongs according to the received connection authentication request transmitted by user equipment 1.

In step S32, routing server 3 transmits a release instruction to routing device 4 to which the target wireless access point corresponding to the identification information belongs based on the release request for requesting to release the target wireless access point transmitted by platform server 2, so that routing device 4 performs release interaction according to the release instruction to obtain release instruction feedback information, which enables release authentication on the target wireless access point to be realized by the routing server and the routing device. The release instruction feedback information may comprise a release success or a release failure. The release success may include but is not limited to: released and to be released.

In step S33, routing server 3 receives the release instruction feedback information transmitted by routing device 4 to which the target wireless access point corresponding to the identification information belongs. In step S34, the release instruction feedback information is transmitted to platform service 2, so that platform server 2 can transmit the release instruction feedback information to user equipment 1. The release instruction feedback information comprises a release failure or a release success.

In step 23, platform server 2 receives the release request feedback information which is returned by routing server 3 based on the release request for requesting to release the target wireless access point selected by user equipment 1, wherein the release request feedback information is the release instruction feedback information transmitted from routing server 3 to platform server 2.

In step S24, platform server 2 transmits the release request feedback information to user equipment 1 as the connection authentication request feedback information which is a response to the connection authentication request transmitted by user equipment 1, so that user equipment 1 can establish a corresponding wireless connection with the target wireless access point based on the connection authentication request feedback information, which enables release authentication on the target wireless access point to be connected which is acquired through scanning by the user equipment by the platform server, the routing device to which the target wireless access point corresponding to the identification information belongs and its routing server, thereby guaranteeing a success rate of wireless connection while simplifying user operations in the process of wireless connection and improving user experience.

Here, at platform server 2, when the release request feedback information is a release success platform server 2 transmits information on the release success to user equipment 1, so that user equipment 1 establishes a wireless connection with the target wireless access point and displays prompt information which indicates that the wireless connection has been established on the wireless network system interface of user equipment 1. Thus the user can timely learn that user equipment 1 which the user holds has established a wireless connection with the target wireless access point, and in turn can perform follow-up operations to surf the Internet wirelessly via the target wireless access point. If the release request feedback information is a release failure, platform server 2 transmits prompt information which indicates that the wireless connection cannot be established with the target wireless access point to user equipment 1, to prompt the user that wireless connection cannot be established with the current target wireless access point. Thus the user can subsequently retry connection or reselect another cooperative wireless access point from the at least one cooperative wireless access point displayed on the user equipment as the current target wireless access point and request for wireless connection.

In step S13, user equipment 1 receives the connection authentication request feedback information returned by platform server 2 based on the release request, wherein the connection authentication request feedback information is returned by routing server 3 after platform server 2 transmits the release request for releasing the target wireless access point to routing server 3 to which routing device 4 belongs, wherein the target wireless access point corresponding to the identification information belongs to routing device 4. Here, the connection authentication request feedback information comprises a connection permission or a connection prohibition. That is, after release authentication is performed by routing device 4 to which the target wireless access point corresponding to the identification information belongs and its routing server 3, if the release authentication feedback information is a release success, the connection authentication request feedback information comprises a connection permission accordingly; if the release authentication feedback information is a release failure, the connection authentication request feedback information comprises a connection prohibition accordingly.

In step S14, when the connection authentication request feedback information is a connection permission, user equipment 1 establishes a wireless connection with the target wireless access point and displays prompt information which indicates that the wireless connection has been established on the wireless network system interface of user equipment 1 (for example, it may be text prompt information which is used to indicate a successful wireless connection or a wireless connection completion, etc., or may be an icon prompt which is used to indicate a successful wireless connection or a wireless connection completion, etc.), which enables the user intuitively and timely to learn the fact that the user equipment has established the wireless connection with the target wireless access point from the wireless network system interface through the prompt information which is used to indicate that the wireless connection has been established. Further, when the connection authentication request feedback information is a connection prohibition, user equipment 1 receives prompt information which is returned by platform server 2 and is used to indicate that wireless connection cannot be established with the target wireless access point; and displays the prompt information which is used to indicate that wireless connection cannot be established with the target wireless access point through the wireless network system interface of user equipment 1 (for example, it may be text prompt information which is used to indicate a wireless connection failure or an abnormal wireless connection, etc., or may be an icon prompt which is used to indicate a wireless connection failure or an abnormal wireless connection, etc.), which enables user equipment 1 to prompt the user that wireless connection cannot be established with the target wireless access point to which the user is making an attempt to connect or that connection may be retried again intuitively with the prompt information which is used to indicate that wireless connection cannot be established with the target wireless access point, and in turn improves user experience.

Through steps S11 to S14, steps S21 to S24, and steps S31 to S34, a wireless connection between the user equipment and the target wireless access point corresponding to the routing device which cooperates with/is authorized by the networking application is realized through pre-release of the target wireless access point by the platform server corresponding to the authorized networking application, which in turn improves success rate of establishing a wireless connection with all the target wireless access points corresponding to the allied/authorized routing device, brings a consistent experience to all users who use this networking application to establish wireless connection with allied hotspots, and is easy to use. One release success is able to realize the wireless connection with the target wireless access point. When the user needs to establish a wireless connection with the cooperative/allied hotspot from the routing device which cooperates with the networking application installed on the user equipment, as long as the user performs a connection operation on at least one wireless access point currently acquired through scanning and displayed by the wireless network system interface of the user equipment, user equipment 1 invokes the platform server corresponding to the networking application installed on user equipment 1, the routing device to which the target wireless access point corresponding to the identification information belongs and its routing server to perform release authentication on wireless connection to the target wireless access point when user equipment 1 detects the connection operation, of which the user is unaware, which in turn enables user equipment 1 to establish a wireless connection with the selected target wireless access point. Cumbersome operations resulting from authentication by inputting user identifier, such as a mobile phone number, etc., or by following a public account in the process of traditional wireless connection, and even security issues such as user information leakage, etc. are avoided, thereby simplifying operations in the process of wireless connection while guaranteeing user privacy safety and improving user experience. The user can timely learn the fact that the wireless connection has been established through the intuitively displayed prompt information by the wireless network system interface which is used to indicate that the user equipment has established the wireless connection with the target wireless access point. Further, operations performed by the user in the process of establishing a wireless connection can be simplified while the result that the wireless connection has been established can also be learned intuitively and timely by the user through the prompt information, which further improves user experience.

In this embodiment, in step S32, routing server 3 transmits a release instruction to the routing device to which the target wireless access point belongs, wherein the release instruction comprises a release rule carrying the identification information of the target wireless access point. For example, the release rule may be:

“token:zi1708015q17c03d4601558b|2082c0ad898b”, which enables the routing device and the routing server to perform release interaction determination.

In step S41, routing device 4 receives a release instruction transmitted by routing server 3, wherein the release instruction comprises a release rule carrying the identification information of the target wireless access point. For example, the release rule may be:

“token:zi1708015q17c03d4601558b|2082c0ad898b”.

In step S42, routing device 4 performs release authentication on the target wireless access point corresponding to the identification information according to the release rule, and determines whether the target wireless access point corresponding to the identification information is a cooperative wireless access point broadcasted by routing device 4. After that, routing device 4 returns the release instruction feedback information to routing server 3, so that routing server 3 transmits the release instruction feedback information to platform server 2. In specific, the step comprises:

if routing device 4 determines that the target wireless access point corresponding to the identification information is a cooperative wireless access point broadcasted by routing device 4, routing device 4 transmits the release instruction feedback information which is used to indicate a release success to routing server 3;

if routing device 4 determines that the target wireless access point corresponding to the identification information is not a cooperative wireless access point broadcasted by routing device 4, routing device 4 transmits the release instruction feedback information which is used to indicate a release failure to routing server 3, which enables routing device 4 to authenticate whether to release the target wireless access point.

Here, the release success may comprise: released or to be released. The fact that the target wireless access point is released is used to indicate that the target wireless access point is currently in a released state. That is, the target wireless access point has been released before. Connection may be made directly to the target wireless access point and wireless connection may be established. The fact that the target wireless access point is to be released is used to indicate that the target wireless access point has not been released before and is currently being released. Connection may be made wirelessly to the target wireless access point and wireless connection may be established.

In this embodiment, when the connection authentication request feedback information received from platform server 3 by user equipment 1 is a connection permission, in step S14, user equipment 1 establishes a wireless connection with the target wireless access point and displays the prompt information which indicates that the wireless connection has been established on the wireless network system interface. After that, the step further comprises:

when it is detected that the wireless connection through the target wireless access point is not working, transmitting a connection retry request for the target wireless access point to the platform server based on a detected reconnection operation on the target wireless access point by the user, wherein the connection retry request comprises the identification information of the target wireless access point (e.g., physical address of the user equipment, etc.), which enables the user to try to request connection to the current target wireless access point again.

According to another aspect of the present application, it is also provided a system for wireless connection. The system comprises a user equipment, a platform server, a routing server and a routing device, wherein:

the user equipment is configured to: scan to acquire and display at least one cooperative wireless access point on a wireless network system interface; transmit a connection authentication request for a target wireless access point of the at least one cooperative wireless access point to a platform server when it is detected that a user performs a connection operation on the target wireless access point, wherein the connection authentication request comprises identification information of the target wireless access point;

the platform server is configured to: receive the connection authentication request for the target wireless access point transmitted by the user equipment, wherein the connection authentication request comprises the identification information of the target wireless access point; and transmit a release request for the target wireless access point to the routing server to which the routing device belongs, wherein the target wireless access point corresponding to the identification information belongs to the routing device;

the routing server is configured to: receive the release request for releasing the target wireless access point transmitted by the platform server, wherein the release request comprises the identification information of the target wireless access point; and transmit a release instruction to the routing device to which the wireless access point corresponding to the identification information belongs, wherein the release instruction comprises a release rule carrying the identification information of the target wireless access point;

the routing device is configured to: receive the release instruction transmitted by the routing server, wherein the release instruction comprises the release rule carrying the identification information of the target wireless access point; and return release instruction feedback information to the routing server after release authentication on the wireless access point corresponding to the identification information based on the release rule, so that the routing server transmits the release instruction feedback information to the platform server, wherein the release instruction feedback information comprises a release success or a release failure;

the platform server is configured to: receive the release request feedback information returned by the routing server; when the release request feedback information is a release success, transmit information on the release success to the user equipment; and

the user equipment is configured to: receive connection authentication request feedback information returned by the platform server, wherein the connection authentication request feedback information comprises a connection permission or a connection prohibition; establish a wireless connection with the target wireless access point when the connection authentication request feedback information indicates a connection permission.

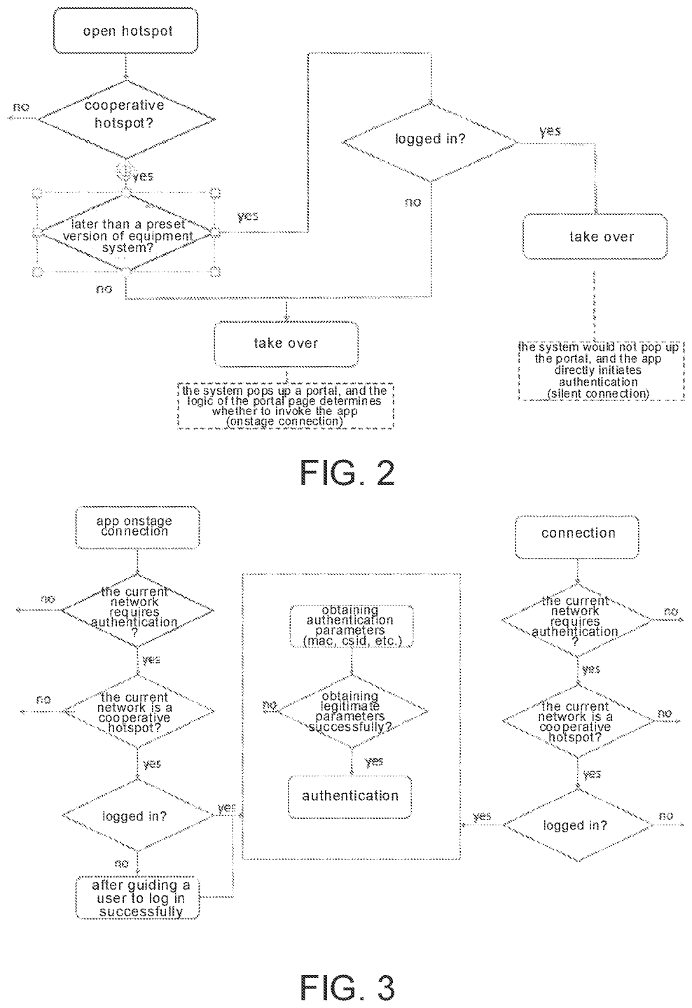

In a practical application scenario of the present application, as shown in FIGS. 2 and 3, when a user equipment scans and acquires all open hotspots open to the user in its vicinity, such as open hotspots of merchants, mobile data open hotspots, etc., the user equipment further scans and acquires all cooperative wireless access points of all open hotspots through its own equipment system, and selects a cooperative wireless access point from one or more cooperative wireless access points to establish authenticated wireless connection. If it is determined that the version of the equipment system of the user equipment is prior to a preset version (e.g., prior to iOS system 11.3, etc.), a Portal page will pop up on the user equipment and a networking application installed on the user equipment, such as an application of WIFI master key, etc., will be launched to authenticate identity information by requiring the user to enter a user account, such as a mobile phone number, etc., or to follow a WeChat public account of a merchant to which the cooperative wireless access point belongs (e.g., authentication is needed by the selected cooperative wireless access point after the user is guided to log in successfully and the user identity is determined, as shown in FIG. 3) in the process of a traditional way of wireless connection to the selected cooperative wireless access point. If it is determined that the version of the equipment system of the user equipment is later than the preset version (e.g., later than iOS system 11.3, etc.) and the user has logged in to the networking application installed on the user equipment which the user holds (user identifier can be acquired to ensure that the user is a legitimate user), the user equipment invokes a platform server corresponding to the networking application installed on user equipment 1, a routing device to which a target wireless access point of the at least one cooperative wireless access point belongs and its routing server to perform a silent connection way of release authentication on the target wireless access point (e.g., to obtain authentication parameters, such as MAC address of a router, hotspot identifier, etc., and determine whether legitimate matching parameters and release authentication are obtained, as shown in FIG. 3), of which the user is unaware, when the user equipment installed with the networking application detects that the user performs a connection operation on the target wireless access point. In the process of authentication: when the user equipment detects the connection operation of the user, the user equipment transmits a connection authentication request for the target wireless access point to the platform server corresponding to the networking application installed on the user equipment, so that the platform server transmits a release request for releasing the target wireless access point to the routing server which cooperates with/is authorized by the networking application based on the connection authentication request. As such, the routing server performs authentication interaction with the routing device based on the release request to obtain release request feedback information on the target wireless access point, and transmits the release request feedback information to the platform server. The platform server returns connection authentication request feedback information to the user equipment based on the release request feedback information. Thus, the routing server and the routing device achieve pre-release of the target wireless access point to be connected acquired through scanning by the user equipment. The user equipment then can establish a wireless connection with the target wireless access point based on the received connection authentication request feedback information which is used to indicate a connection permission, and display prompt information on the wireless network system interface which indicates that the wireless connection has been established. Not only that the user can establish a wireless connection between the user equipment and the selected target wireless access point so as to acquire the wireless network as long as the user performs a connection operation on at least one wireless access point currently acquired through scanning and displayed by the wireless network system interface of the user equipment, but that the user is also able to timely learn the fact that the wireless connection has been established through the intuitively displayed prompt information by the wireless network system interface which is used to indicate that the user equipment has established the wireless connection with the target wireless access point, so that not only operations performed by the user in the process of establishing a wireless connection can be simplified, but also the result that the wireless connection has been established can be learned intuitively and timely by the user through the prompt information, which further improves user experience.

According to another aspect of the present application, it is also provided a nonvolatile storage medium having computer-readable instructions stored thereon. The computer-readable instructions, executable by a processor, cause the processor to implement the above mentioned method for wireless connection.

According to a further aspect of the present application, it is also provided a user equipment for wireless connection. The user equipment comprises:

one or more processors; and

a nonvolatile storage medium for storing one or more computer-readable instructions,

wherein the one or more computer-readable instructions, when executed by the one or more processors, cause the one or more processors to implement the above mentioned method, implemented at a user equipment, for wireless connection.

Here, the detailed contents of each of the embodiments in the user equipment for wireless connection can be made reference to corresponding parts of the embodiments of the method, implemented at the user equipment, for wireless connection, and details are not described herein again.

According to another aspect of the present application, it is also provided a platform server for wireless connection. The platform server comprises:

one or more processors; and

a nonvolatile storage medium for storing one or more computer-readable instructions,

wherein the one or more computer-readable instructions, when executed by the one or more processors, cause the one or more processors to implement the above mentioned method, implemented at the platform server, for wireless connection.

Here, the detailed contents of each of the embodiments in the platform server for wireless connection can be made reference to corresponding parts of the embodiments of the method, implemented at the platform server, for wireless connection, and details are not described herein again.

According to another aspect of the present application, it is also provided a routing server for wireless connection. The routing server comprises:

one or more processors; and

a nonvolatile storage medium for storing one or more computer-readable instructions,

wherein the one or more computer-readable instructions, when executed by the one or more processors, cause the one or more processors to implement the above mentioned method, implemented at the routing server, for wireless connection.

Here, the detailed contents of each of the embodiments in the routing server for wireless connection can be made reference to corresponding parts of the embodiments of the method, implemented at the routing server, for wireless connection, and details are not described herein again.

According to a further aspect of the present application, it is also provided a routing device for wireless connection. The routing device comprises:

one or more processors; and

a nonvolatile storage medium for storing one or more computer-readable instructions,

wherein the one or more computer-readable instructions, when executed by the one or more processors, cause the one or more processors to implement the above mentioned method, implemented at a routing device, for wireless connection.

Here, the detailed contents of each of the embodiments in the routing device for wireless connection can be made reference to corresponding parts of the embodiments of the method, implemented at the routing device, for wireless connection, and details are not described herein again.

Summing up, in the embodiments of the present application, when a user needs to establish a wireless connection with a wireless hotspot which cooperate/is allied with a platform installed on a user equipment, the user only needs to perform a connection operation on at least one cooperative wireless access point currently acquired through scanning and displayed by a wireless network system interface of the user equipment, so that the user equipment invokes a platform server corresponding to the platform, and the routing device to which the target wireless access point belongs and its routing server in the background to authenticate wireless connection to the target wireless access point as soon as the user equipment detects the connection operation, and thus the wireless connection between the user equipment and the target wireless access point is implemented so as to acquire a wireless network. The user can also timely learn the fact that the wireless connection has been established through the intuitively displayed prompt information on the wireless network system interface of the user equipment to the user which is used to indicate that the user equipment has established the wireless connection with the target wireless access point, so that not only operations performed by the user in the process of establishing a wireless connection can be simplified (the user can invoke release authentication on and wireless connection to the target wireless access point of the at least one cooperative wireless access point displayed by the wireless network system interface of the user equipment as long as the user performs the connection operation on the target wireless access point), but also the result that the wireless connection has been established can be learned intuitively and timely by the user through the prompt information from the wireless network system interface, which further improves user experience.

It should be noted that the present application can be implemented in software and/or a combination of software and hardware, for example, by using an application specific integrated circuit (ASIC), a general purpose computer, or any other similar hardware device. In one embodiment, the software program of the present application can be executed by a processor to implement the steps or functions described above. Likewise, the software programs (including related data structures) of the present application can be stored in a computer readable storage medium such as a RAM memory, a magnetic or optical drive or a floppy disk and the like. In addition, some of the steps or functions of the present application may be implemented in hardware, for example, as a circuit that cooperates with a processor to perform various steps or functions.

In addition, a portion of the present application can be embodied as a computer program product, such as computer program instructions, when executed by a computer, can invoke or provide a method and/or technical solution in accordance with the present application. The program instructions for invoking the method of the present application may be stored in a fixed or removable storage medium, and/or transmitted by a data stream in a broadcast or other signal carrier medium, and/or stored in a working memory of the computer device in which the program instructions run. Herein, an embodiment in accordance with the present application includes an apparatus including a memory for storing computer program instructions and a processor for executing program instructions, wherein when the computer program instructions are executed by the processor, triggering the apparatus to operate the above mentioned methods and/or technical solutions in accordance with various embodiments of the present application.

For those skilled in the art, it is apparent that the present application is not limited to the details of the above-mentioned exemplary embodiments, and the present application can be implemented in other specific forms without departing the spirit or basic features of the present application. Therefore, the present embodiments are to be considered as illustrative and not restrictive. The scope of the present application is defined by the appended claims rather than the above-mentioned description, and therefore it is intended that all changes which fall within the meaning and range of equivalency of the claims are embraced in the present application. Any reference signs in the claims should not be construed as limiting the claims involved. In addition, it is apparent that the word “comprising” does not exclude other elements or steps, and the singular does not exclude the plural. A plurality of units or means stated in the apparatus claims may also be implemented by one unit or means by means of software or hardware. The terms first and second are used to represent names, and are not used to represent any particular order.

What is claimed is:

1. A method, implemented at a user equipment, for wireless connection, the method comprising:
scanning to acquire and display at least one cooperative wireless access point on a wireless network system interface;
transmitting a connection authentication request for a target wireless access point of the at least one cooperative wireless access point to a platform server when it is detected that a user performs a connection operation on the target wireless access point, wherein the connection authentication request comprises identification information of the target wireless access point;
receiving the connection authentication request feedback information returned by the platform server, wherein the connection authentication request feedback information comprises a connection permission or a connection prohibition; and
establishing a wireless connection with the target wireless access point when the connection authentication request feedback information is a connection permission.

2. The method according to claim 1, wherein when the connection authentication request feedback information is a connection prohibition:
receiving prompt information which is returned by the platform server and is used to indicate that a wireless connection cannot be established with the target wireless access point; and
displaying the prompt information which is used to indicate that a wireless connection cannot be established with the target wireless access point via the wireless network system interface.

3. The method according to claim 1, wherein transmitting the connection authentication request for the target wireless access point of the at least one cooperative wireless access point to the platform server when it is detected that the user performs the connection operation on the target wireless access point comprising:
invoking a networking application installed on the user equipment in the background and transmitting, by the networking application, the connection authentication request for the target wireless access point to the corresponding platform server when it is detected that the user performs the connection operation on the target wireless access point of the at least one cooperative wireless access point.

4. The method according to claim 3, wherein at the same time when invoking the networking application installed on the user equipment in the background, the method further comprising:
transmitting, by the networking application, a query request to the platform server, wherein the query request comprises the identification information of the target wireless access point, so that the platform server queries whether the target wireless access point corresponding to the identification information is a cooperative wireless access point, and if so, the platform server returns, to the networking application, query request feedback information which is used to indicate that the target wireless access point is a cooperative wireless access point; and
transmitting the connection authentication request for the target wireless access point to the platform server when the networking application receives, from the platform server, the query request feedback information which indicates that the target wireless access point is a cooperative wireless access point.

5. The method according to claim 1, wherein after establishing the wireless connection with the target wireless access point when the connection authentication request feedback information is a connection permission, the method further comprising:
when it is detected that the wireless connection through the target wireless access point is not working, transmitting a connection retry request for the target wireless access point to the platform server based on a detected reconnection operation on the target wireless access point by the user, wherein the connection retry request comprises the identification information of the target wireless access point.

6. A method, implemented at a platform server, for wireless connection, the method comprising:
receiving a connection authentication request for a target wireless access point transmitted by a user equipment, wherein the connection authentication request comprises identification information of the target wireless access point;
transmitting a release request for the target wireless access point to a routing server to which a routing device belongs, wherein the target wireless access point corresponding to the identification information belongs to the routing device;
receiving release request feedback information returned by the routing server; and
when the release request feedback information is a release success, transmitting information on the release success to the user equipment, so that the user equipment establishes a wireless connection with the target wireless access point.

7. The method according to claim 6, wherein if the release request feedback information is a release failure, transmitting, to the user equipment, prompt information which is used to indicate that a wireless connection cannot be established with the target wireless access point, so that the user equipment displays the prompt information which is used to indicate that a wireless connection cannot be established with the target wireless access point via the wireless network system interface.

8. A method, implemented at a routing server, for wireless connection, the method comprising:
receiving a release request for releasing a target wireless access point transmitted by a platform server, wherein the release request comprises identification information of the target wireless access point;
transmitting a release instruction to a routing device to which the wireless access point corresponding to the identification information belongs, wherein the release instruction comprises a release rule carrying the identification information of the target wireless access point; and
receiving release instruction feedback information transmitted by the routing device, and transmitting the release instruction feedback information to the platform server, so that the platform server transmits the release instruction feedback information to a user equipment, wherein the release instruction feedback information comprises a release success or a release failure.

9. A method, implemented at a routing device, for wireless connection, the method comprising:
receiving a release instruction transmitted by a routing server, wherein the release instruction comprises a release rule carrying identification information of a target wireless access point; and
returning release instruction feedback information to the routing server after release authentication on the target wireless access point corresponding to the identification information is performed based on the release rule, so that the routing server transmits the release instruction feedback information to the platform server, wherein the release instruction feedback information comprises a release success or a release failure.

10. A system for wireless connection, the system comprising a user equipment, a platform server, a routing server and a routing device, wherein:
the user equipment is configured to: scan to acquire and display at least one cooperative wireless access point on a wireless network system interface; transmit a connection authentication request for a target wireless access point of the at least one cooperative wireless access point to the platform server when it is detected that a user performs a connection operation on the target wireless access point, wherein the connection authentication request comprises identification information of the target wireless access point;
the platform server is configured to: receive the connection authentication request for the target wireless access point transmitted by the user equipment, wherein the connection authentication request comprises the identification information of the target wireless access point; and transmit a release request for the target wireless access point to the routing server to which the routing device belongs, wherein the wireless access point corresponding to the identification information belongs to the routing device;
the routing server is configured to: receive the release request for releasing the target wireless access point transmitted by the platform server, wherein the release request comprises the identification information of the target wireless access point; and transmit a release instruction to the routing device to which the wireless access point corresponding to the identification information belongs, wherein the release instruction comprises a release rule carrying the identification information of the target wireless access point;
the routing device is configured to: receive the release instruction transmitted by the routing server, wherein the release instruction comprises the release rule carrying the identification information of the target wireless access point; and return release instruction feedback information to the routing server after release authentication on the target wireless access point corresponding to the identification information is performed based on the release rule, so that the routing server transmits the release instruction feedback information to the platform server, wherein the release instruction feedback information comprises a release success or a release failure;
the platform server is configured to: receive the release request feedback information returned by the routing server; when the release request feedback information is a release success, transmit information on the release success to the user equipment; and
the user equipment is configured to: receive a connection authentication request feedback information returned by the platform server, wherein the connection authentication request feedback information comprises a connection permission or a connection prohibition; establish a wireless connection with the target wireless access point when the connection authentication request feedback information is a connection permission.

11. A nonvolatile storage medium having computer-readable instructions stored thereon, wherein the computer-readable instructions, executable by a processor, cause the processor to implement the method as recited in claim 1.

12. A user equipment for wireless connection, the user equipment comprising:
one or more processors; and
a nonvolatile storage medium for storing one or more computer-readable instructions,
wherein the one or more computer-readable instructions, when executed by the one or more processors, cause the one or more processors to implement the method as recited in claim 1.

13. A platform server for wireless connection, the platform server comprising:
one or more processors; and
a nonvolatile storage medium for storing one or more computer-readable instructions,
wherein the one or more computer-readable instructions, when executed by the one or more processors, cause the one or more processors to implement the method as recited in claim 6.

14. A routing server for wireless connection, the routing server comprising:
one or more processors; and
a nonvolatile storage medium for storing one or more computer-readable instructions,
wherein the one or more computer-readable instructions, when executed by the one or more processors, cause the one or more processors to implement the method as recited in claim 8.

15. A routing device for wireless connection, the routing device comprising:
one or more processors; and
a nonvolatile storage medium for storing one or more computer-readable instructions,
wherein the one or more computer-readable instructions, when executed by the one or more processors, cause the one or more processors to implement the method as recited in claim 9.
